(19) United States
(12) Patent Application Publication
(10) Pub. No.: US 2001/0050949 A1
(43) Pub. Date: Dec. 13, 2001

(54) SPEED-SPECTRUM DEMODULATION SYSTEM FOR SUPPRESSION OF INTERFERING SIGNALS

(76) Inventors: CHARLES A. POPECK, CEDAR RAPIDS, IA (US); GARY B. GREEN, CEDAR RAPIDS, IA (US); JEFFREY L. TUOHINO, CEDAR RAPIDS, IA (US); JEFFREY J. JORGENSEN, CEDAR RAPIDS, IA (US)

Correspondence Address: ROCKWELL COLLINS INC, ATTN KYLE EPPELE, 400 COLLINS ROAD NE, CEDAR RAPIDS, IA, 52498

(21) Appl. No.: 08/901,039

(22) Filed: Jul. 25, 1997

(51) Int. Cl. H04K 1/00

(52) U.S. Cl. 375/148

(57) ABSTRACT

A spread-spectrum demodulation system which can separate known incoming broad-band signals from a received signal, allowing separation of interfering signals and acquisition and tracking of multiple signals with widely varying power. Each signal is despread using a locally generated code, and then separated by narrow-band excision. The effect of that locally generated code on each of the remaining signals is eliminated by mixing again with a locally generated code.

### BACKGROUND

The present invention relates to spread-spectrum signal acquisition and tracking, and more specifically to suppression of an interfering signal and to separation of multiple interfering signals with large power variations.

The communication or navigation systems of interest often operate in an environment with a variety of interfering signals of varying power. The presence of an interfering signal can have the effect of preventing access to a desired signal, and of preventing use of the communication or navigation system. Such conditions may arise due to accidental or intentionally imposed interference situations.

There may be an environment with many spread-spectrum signals with overlapping spectrums. They may be emitted from different sources in different locations, and a user may need to access one or more signals that have far lower received power than other incoming spread-spectrum signals. The relatively high power of the higher power signals may prevent access to the lower power signals. One example is the “near-far” problem of terrestrial navigation systems that use spread signals for ranging. Current systems are designed to accommodate the problem rather than to solve it. For instance, signal pulsing reduces the effects of interference but also reduces signal power.

Although many existing techniques address the suppresion of narrow-band interfering signals in communications systems, far fewer techniques address the suppression of broad-band, or spread-sprectrum, interfering signals. There currently are antenna-based techniques for reducing the effects of wide-band interference, but these techniques require an expensive antenna and associated antenna electronics.

Many systems for processing transmitted data, such as communication or navigation systems, concern transmissions modulated by pseudo-random noise codes. A pseudo-random noise code refers to a systematically generated noise code which is derived from a sequence, but which often is long enough to appear to be random. When a relatively narrow-band signal is modulated by a pseudo-random noise code digital signal, the relatively narrow-band signal is spread across a very wide band of the frequency spectrum and appears as noise to receivers. However, the incoming signal may be demodulated by mixing it with an identical locally generated pseudo-random noise code, effectively despreading the signal and revealing the original relatively narrow-band signal.

While the pseudo-random noise code and its bit rate are known in advance, or at least the pseudo-random noise code is known to be one of a limited set of such codes, the receiver must synchronize the identical locally generated code so that it is in phase with the incoming pseudo-random noise code. In the mixing operation, the resulting imposition of the two identical pseudo-random noise code digital signals on the original relatively narrow-band signal yields that despread original signal if the two codes are perfectly synchronized. In effect,

P₁(t)*P₁(t)=1,

where Pᵢ(t) is a particular pseudo-randum noise code and, as is typically done in such explanatory representations, the symbol * depicts an appropriate mixing operation.

One embodiment of the present invention separates a spread-spectrum signal (which has been modulated prior to transmission by a known or ascertainable pseudo-random noise code) from a received signal. In the case of a relatively high power interfering signal, a locally generated pseudo-random noise code digital signal is generated which is identical to the code modulating the interfering signal. The two codes are synchronized, and mixing of the received signal and the locally generated code despreads the interfering signal. (That is, the mixing collapses the spectrum of the interfering signal to the relatively narrow band it occupied prior to the pre-transmission modulation by the pseudo-random noise code.) The resulting signal includes the collapsed or despread interfering signal, together with the other (probably lower power) incoming signals which now have been mixed with the locally generated code.

This resulting signal is applied to a narrow-band excisor which is designed to separate the despread interfering signal. The residual signal, from the output of the narrow-band excisor, is again mixed with the same locally generated code to eliminate the spreading effect of that code on the desired incoming signals. In this way, access is achieved to the signals which had been inaccessible due to the relatively high power, spread-spectrum, interfering signal.

Of course, the interfering signal also may be a desired signal. Indeed, it may be desirable to acquire and track multiple spread-spectrum signals which interfere with each other and which have widely varying power from signal to signal. Each signal of interest may be separated as described above, and separation of each of the most accessible signals renders the remaining signals more accessible.

### BRIEF DESCRIPTION OF THE DRAWINGS

FIG. 1 is an example block diagram of a signal conditioning circuit.

FIG. 2 is a block diagram of one embodiment of a circuit for separation of an interfering signal.

FIG. 3 is a block diagram of one embodiment of a circuit for separation of an interfering signal, where the remainder signal also includes a desired spread-spectrum signal which is despread at the same time that the effect of the interfering code is eliminated.

FIG. 4 is a block diagram of one embodiment of a circuit for separation of an interfering signal using software operations.

FIG. 5 is a block diagram of one embodiment of a circuit for processing multiple signals.

FIG. 6 is a block diagram of one embodiment of a circuit for processing multiple signals, with a switching network which allows the same initial signal to be applied to different channels.

### DETAILED DESCRIPTION OF THE INVENTION

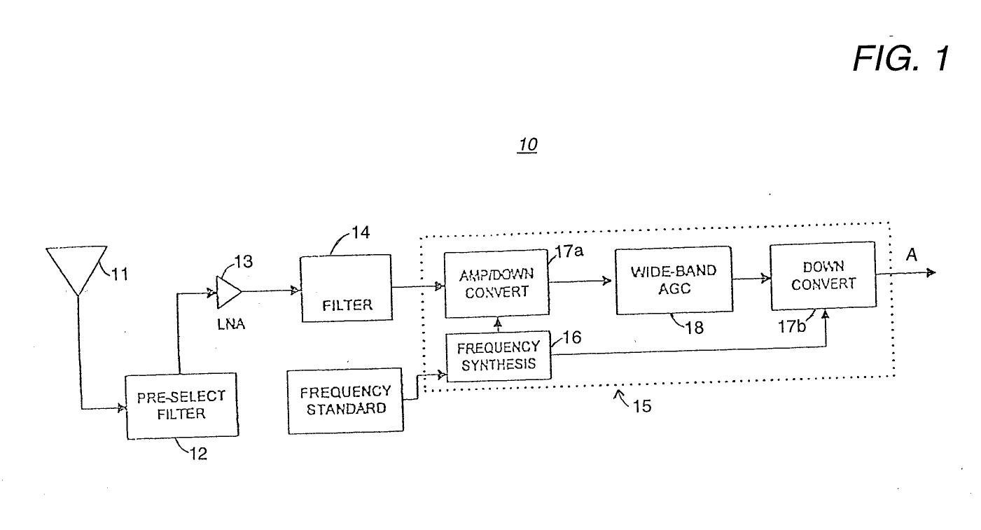

It may be desirable to perform certain front-end signal processing functions in connection with an unconditioned received signal. If such signal conditioning is used, there many ways known to implement it. FIG. 1 is a block diagram of an example of one possible circuit 10 for optional signal conditioning. FIG. 1 includes an antenna 11, a pre-selection filter 12, a linear amplifier 13, and additional filtering 14 (e.g., to eliminate any undesired effects introduced by the amplifier). Signal conditioning circuit 10 also includes circuitry 15 for signal level control and down conversion from a high transmission frequency to an intermediate frequency more suitable for the desired processing. In the example in FIG. 1, the down conversion and signal level control of circuitry 15 includes frequency synthesizer 16, amplifier/down converter 17a, down converter 17b, and a wide-band automatic gain controller 18. The resulting signal at point A in FIGS. 1 through 4 may be labelled the “received” signal.

A simplified version of the received signal at point A in FIGS. 1 through 4 may be represented as

S_{A}(t)=I(t)+R(t),

where I(t) is an incoming interfering signal and R(t) is an incoming remainder signal. I(t) might be used for communication, data link, or ranging purposes. Information might be extracted which is intrinsic to I(t), such as that which may be derived from information-bearing bits. Other information might be extracted by tracking I(t), such as ranging information or velocity information. However, in some conditions, the relatively high power of I(t) can prevent access to R(t), from which other desirable information may be derived.

For explanatory purposes, a simplified version of the interfering signal may be represented as

I(t)=P₁(t)* cos(ω₁t),

where P₁(t) is the pseudo-random noise code digital signal modulating the interfering signal prior to its transmission. Again, as is typically done in such explanatory representations, the symbol * depicts an appropriate operation. Amplitudes, phase shifts, and any relatively narrow-band information signal modulating the interfering signal are not important for this discussion and are not reflected in the equation.

As the interfering signal is relatively strong, the received signal may be spread-spectrum processed in one embodiment by a code and carrier loop, which locally generates P₁(t)—the pseudo-random noise code which modulates the interfering signal. By any of various known approaches, the loop operates to synchronize the locally generated pseudo-random noise code with the identical code modulating the incoming interfering signal. The loop may accomplish this by time-shifting the locally generated code to lock onto and track the incoming coded signal.

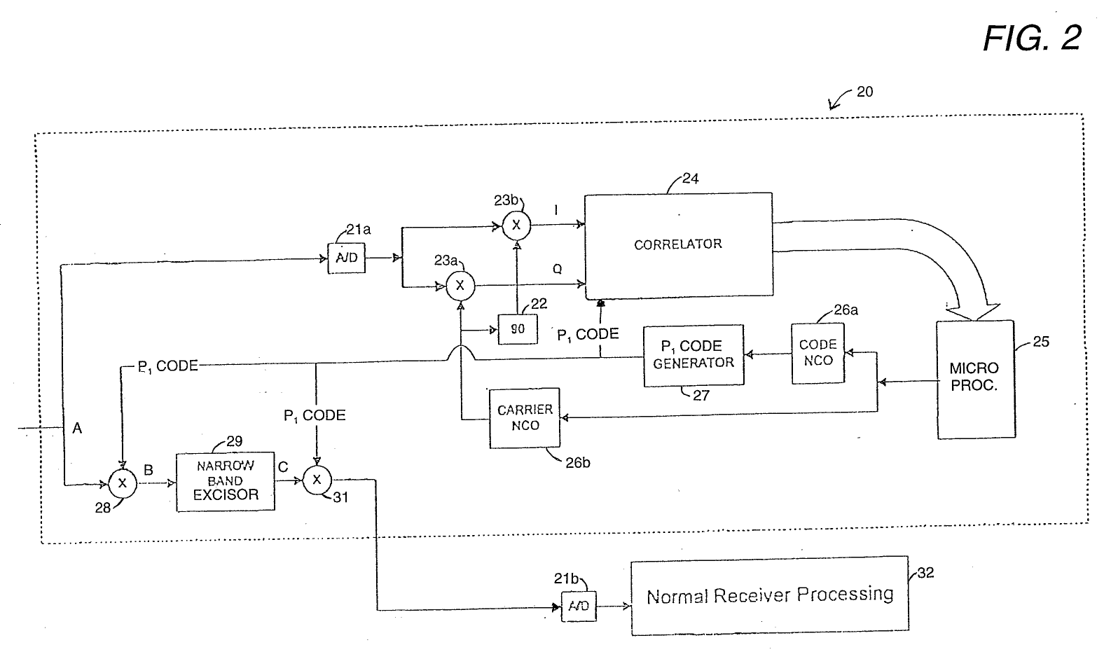

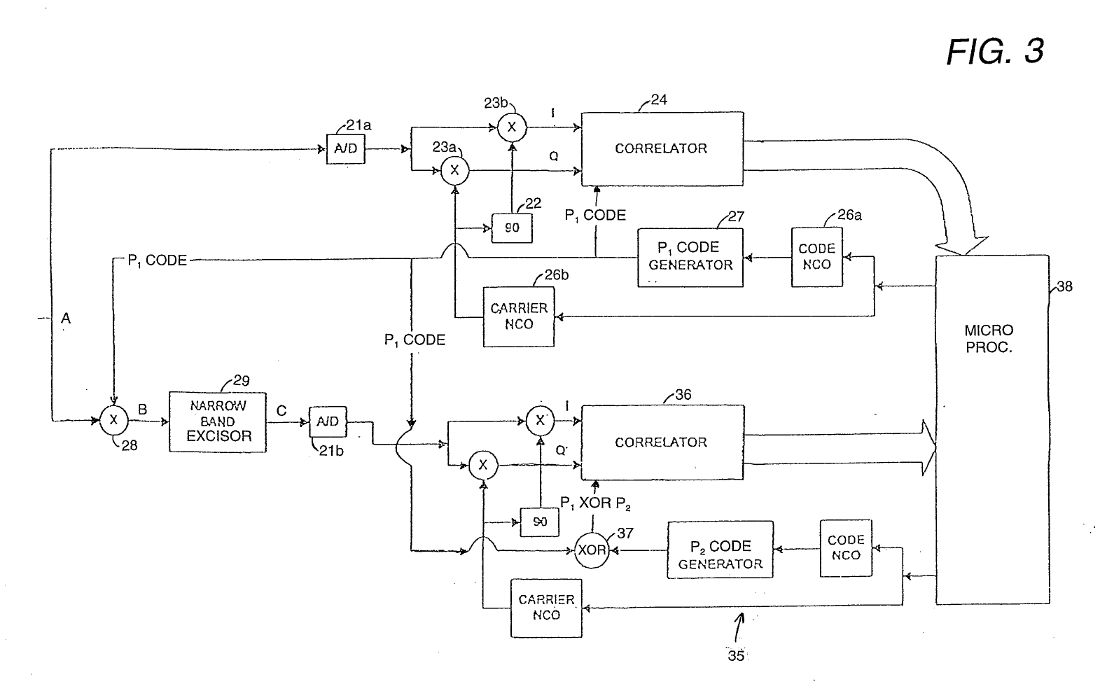

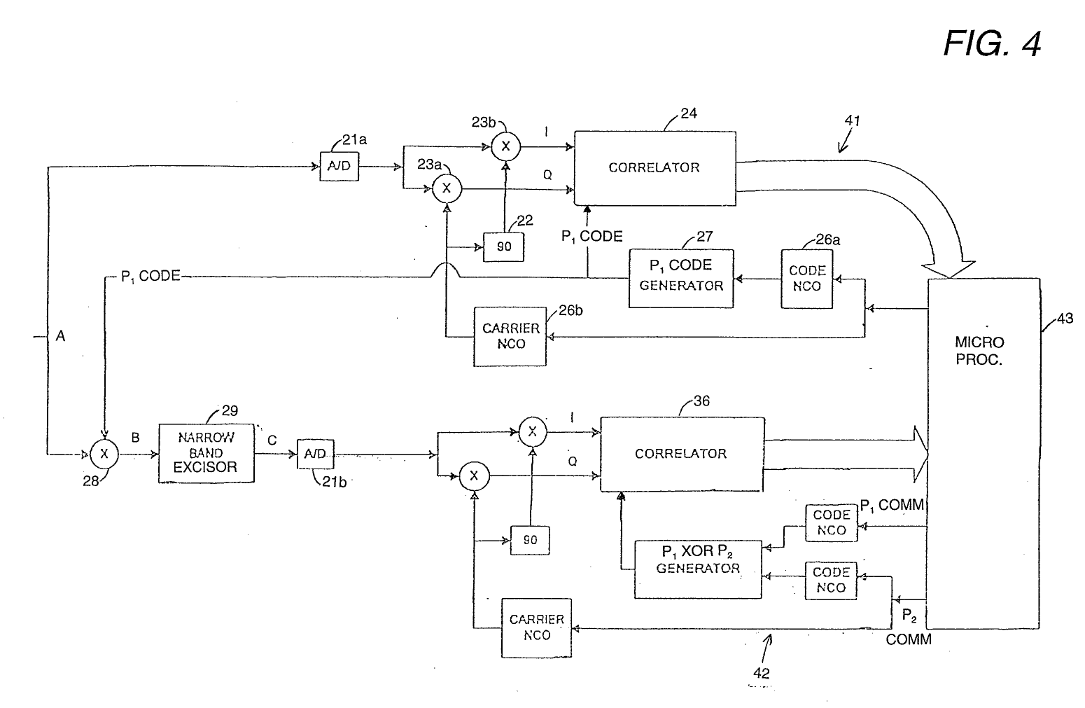

Block diagrams of examples of the loop circuitry are included in FIGS. 2, 3, and 4. Block 21a is an analog to digital converter which may be present. The example code and carrier loop in FIG. 2 includes 90° phase shifter 22, multipliers or mixers 23a and 23b, correlator 24 having in-phase (I) and quadrature (Q) input signals, micro-processor 25, numerically controlled oscillators 26a and 26b, and code generator 27. FIGS. 3 and 4 include block diagrams of similar code and carrier loops.

As discussed above, achieving synchronization enables despreading of the relatively strong interfering signal. That is, when the incoming interfering signal (still modulated by the pseudo-random noise code) is mixed with the identical locally generated code (which has been synchronized with the incoming code), then the spectrum of that interfering signal collapses to the relatively narrow band it occupied prior to the pre-transmission modulation by the pseudo-random noise code. If, as mentioned above, information is to be extracted from the despread signal, it is available from the micro-processor 25 shown in FIG. 2. That signal also would be available from point B, possibly after band-pass filtering if necessary.

However, for purposes of obtaining access to the incoming remainder signal R(t), the function of the code and carrier loop of the example mentioned above is to acquire and maintain synchronization between the locally generated P₁(t) and the identical incoming pseudo-random noise code. The locally generated P₁(t) is mixed with the received signal S_{A}(t), in mixer 28 in the embodiments illustrated in FIGS. 2 through 4. The resulting signal at point B in FIGS. 2 through 4 may be represented as

$$\begin{matrix}{S}_{B} ( t ) = {P}_{1} ( t ) * {S}_{A} ( t ) \\ = {P}_{1} ( t ) * \{ {P}_{1} ( t ) * cos ( {ω}_{1} t ) + R ( t ) \} \\ = {P}_{1} ( t ) * {P}_{1} ( t ) * cos ( {ω}_{1} t ) + {P}_{1} ( t ) * R ( t ) \\ = cos ( {ω}_{1} t ) + {P}_{1} ( t ) * R ( t ) ,\end{matrix}$$

since

P₁(t)*P₁(t)=1.

Therefore, the signal at point B, in the embodiments of FIGS. 2, 3, and 4, includes the despread interfering signal which (due to the despreading) is confined to a relatively narrow-band, and the desired remainder signal mixed with the locally generated P₁(t). In the embodiments of FIGS. 2, 3, and 4, this signal is applied to a narrow-band excisor 29 to eliminate the relatively strong interfering signal which could have inhibited access to the remainder signal. As mentioned above, any information component of the interfering signal is not reflected in these simplified representations.

In some applications, the frequency w of the interfering signal is known in advance or is known to be within a relatively narrow band. In other applications, that frequency will be determined and the narrow-band excisor 29 may be adjusted accordingly. In the embodiments discussed, the narrow-band excisor 29 will have negligible impact on the remainder signal which has been mixed with P₁(t) and, consequently, made into a spread-spectrum signal even if it was not already a broad-band signal.

There are many means known for achieving narrow-band excising. Some of the many examples may include the use of physical devices, and some may include the use of software filtering. A notch filter is one possible narrow-band excisor. Some other examples include those which use time domain adaptive filtering, frequency domain adaptive filtering, or amplitude domain adaptive filtering. A surface acoustic wave device is one example of implementing time domain adaptive filtering. In some embodiments, frequency domain adaptive filtering can be implemented using fast Fourier transformation. These are merely a few suitable examples, but any of many techniques can be used.

The particular application and the nature of the remainder signal may affect the preferability of one technique or another. It is noted that the examples of FIGS. 2, 3, and 4 show analog to digital converter 21b, but it is a design choice whether to use converter 21b and where to place it in the circuit. The technique for narrow-band excising will be affected if, for example, the signal applied to the narrow-band excisor is a digital signal. Furthermore, for the purpose of gaining access to the remainder signal, the point is to separate the interfering signal. A narrow-band excisor may be chosen simply to eliminate the relatively narrow-band interfering signal at this point in the system. However, this is not a necessary approach, and a technique can be chosen so that the separated interfering signal remains available.

The output of the narrow-band excisor 29 at point C in FIGS. 2 through 4 may be labelled the “residual” signal. As indicated above, it may be represented as P₁(t)*R(t), because P₁(t) had been mixed with the received signal S_{A}(t) before application to the narrow-band excisor 29. The residual signal is again mixed with the locally generated P₁(t) to eliminate the spreading effect on the remainder signal R(t),

P₁(t)*P₁(t)*R(t)=R(t).

To eliminate that spreading effect, it is necessary that the P₁(t) mixed with the residual signal has remained in synchronization. There is likely to be a delay which depends on characteristics of the narrow-band excisor, so the P₁(t) mixed with the residual signal would have to be delayed to remain in synchronization following the narrow-band excision. This is another consideration in connection with the technique chosen for the narrow-band excisor.

Thus, I(t) is despread and then separated, achieving access to R(t) which otherwise can be inaccessible due to the relatively high power, spread-spectrum, interfering signal I(t). FIG. 2 shows one embodiment in which the residual signal is mixed with the locally generated pseudo-random noise code digital signal in mixer 31. The desired remainder signal R(t) at the output of mixer 31 then may be processed, as it normally would have been processed without interference, as indicated in block 32 of FIG. 2. While other figures show a more integrated approach, a circuit such as circuit 20 in FIG. 2 can be made as a standalone insertable module.

R(t) also can include a broad-band, spread-spectrum signal, which is modulated by another known pseudo-random noise code digital signal P₂(t) prior to transmission. In that case, the normal processing represented by block 32 in FIG. 2 can involve another code and carrier loop to synchronize a locally generated code P₂(t) with the identical code modulating the signal of interest in R(t). FIG. 3 shows a different embodiment, in which the operation of mixing of the locally generated P₁(t) with the residual signal resulting at point C is incorporated into the second code and carrier loop 35.

The second loop 35 operates directly on the signal P₁(t)*R(t) (instead of first despreading that signal, as is done through mixer 31 in the embodiment in FIG. 2). In the embodiment in FIG. 3, that signal is mixed in correlator 36 with a composite pseudo-random noise code formed from P₁(t) and P₂(t). The synchronized locally generated P₁(t) is available, as before, from the P₁ code generator 27 in the first loop. If R(t) may be represented in a simplified form as

R(t)=P₂(t)* cos(ω₂t),

then the residual signal at point C may be represented as

S_{C}(t)=P₁(t)*P₂(t)* cos(ω₂t).

Mixing that signal with the composite code in correlator 36 despreads the desired signal in R(t). That is,

$$\begin{matrix}{P}_{1} ( t ) * {P}_{2} ( t ) * {S}_{C} ( t ) = {P}_{1} ( t ) * {P}_{1} ( t ) * {P}_{2} ( t ) * {P}_{2} ( t ) * cos ( {ω}_{2} t ) \\ = cos ( {ω}_{2} t ) .\end{matrix}$$

Therefore, the second loop 35 in FIG. 3 is designed to synchronize the locally generated P₂(t) with the identical incoming pseudo-random noise code, making the synchronized P₂(t) available to form the composite code with P₁(t). In the example of FIG. 3, this is done through “exclusive or” gate 37. Information can be extracted from the despread desired signal from micro-processor 38 in the example of FIG. 3.

The embodiment of FIG. 4 is a variation on the example of FIG. 3. P₁(t) and P₂(t) software commands are mixed together through software operations. That is, software operates in real time to generate the locally generated composite code and to control its phasing. Many other possibilities exist to generate and synchronize the necessary code. FIG. 4 is simply an example of many possible embodiments, such as use of an all digital receiver.

In an embodiment of FIG. 4, P₁ code commands are developed in micro-processor 43, as part of the process of the first code and carrier loop 41 of synchronizing the locally generated P₁(t) with the identical code modulating the incoming interfering signal. P₂ code commands are developed in micro-processor 43 as part of the process of the second code and carrier loop 42. As in the example of FIG. 3, the second loop 42 operates on a signal which has been modulated by both P₁(t) and P₂(t). Therefore, as in the example of FIG. 3, a composite code formed from P₁(t) and P₂(t) is applied to correlator 36 (instead of just applying P₂(t)). However, in the example of FIG. 4, the composite code is generated through software operations.

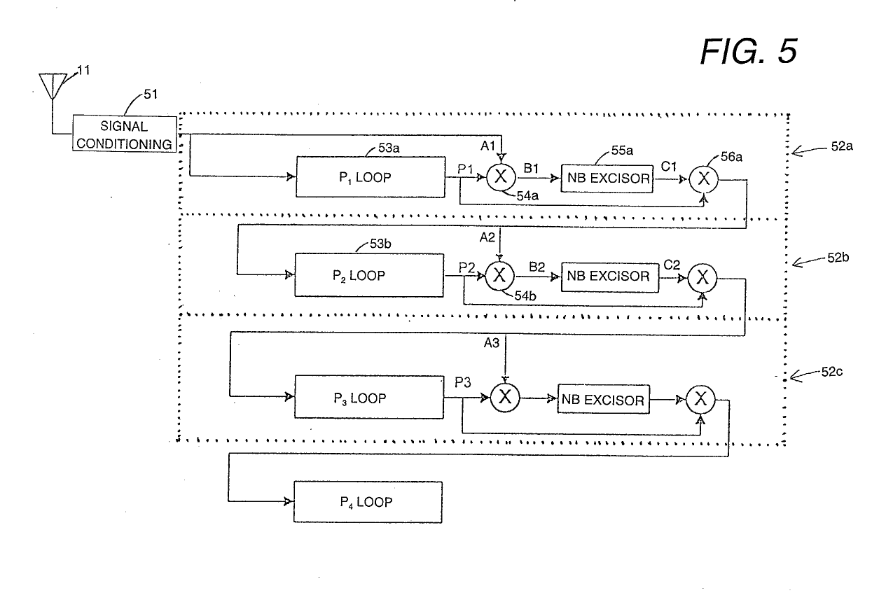

FIG. 5 is an example of the invention in which the received signal includes multiple spread-spectrum signals from which the extraction of information is desired. There may be varying power from signal to signal, and the signals may interfere with each other. The embodiment of FIG. 5 includes signal conditioning in block 51, which can be similar to the example of circuit 10 in FIG. 1. After the optional signal conditioning, the received signal is processed through a number of channels. FIG. 5 is an example in which four spread-spectrum signals are processed.

A simplified version of the received signal at point A1 in FIG. 5 may be represented as

S_{A1}(t)=P₁(t)* cos(ω₁t)+P₂(t)* cos(ω₂t)+P₃(t)* cos(ω₃t)+P₄(t)* cos(ω₄t),

where P₁(t) through P₄(t) are known or ascertainable pseudo-random noise code digital signals respectively modulating the desired signals. Again, the information components of these incoming signals are not reflected in these simplified representations. A first signal is despread and separated in the first channel 52a, as discussed above. Desired information can be recovered from that despread signal, but the residual signal at point C1 in FIG. 5 is free of any interference from the first signal.

In the P₁ code and carrier loop 53a in the embodiment of FIG. 5, the locally generated P₁(t) is synchronized with the identical pseudo-random noise code modulating the first signal. The received signal at point A1 is mixed with the locally generated P₁(t) in mixer 54a, in order to despread the first signal. The signal at point B1 in FIG. 5 may be represented as

$$\begin{matrix}{S}_{B1} ( t ) = {P}_{1} ( t ) * {S}_{A1} ( t ) \\ = cos ( {ω}_{1} t ) + {P}_{1} ( t ) * {P}_{2} ( t ) * cos ( {ω}_{2} t ) + {P}_{1} ( t ) * \\ {P}_{3} ( t ) * cos ( {ω}_{3} t ) + {P}_{1} ( t ) * {P}_{4} ( t ) * cos ( {ω}_{4} t ) .\end{matrix}$$

In the embodiment of FIG. 5, the despread first signal is then separated by narrow-band excisor 55a. The residual signal at point C1 in FIG. 5 is mixed with the locally generated P₁(t) in mixer 56a, to eliminate the effect of that code on the residual signal at point C1.

The remainder signal of the first channel 52a is the initial signal of the next channel 52b at point A2 in FIG. 5. It is essentially the same as the received signal at point A1 in FIG. 5, except that the first signal has been separated and is not interfering with the other signals.

$$\begin{matrix}{S}_{A2} ( t ) = {P}_{1} ( t ) * {S}_{C1} ( t ) \\ = {P}_{1} ( t ) * {P}_{1} ( t ) * {P}_{2} ( t ) * cos ( {ω}_{2} t ) + {P}_{1} ( t ) * {P}_{1} ( t ) * {P}_{3} ( t ) * \\ cos ( {ω}_{3} t ) + {P}_{1} ( t ) * {P}_{1} ( t ) * {P}_{4} ( t ) * cos ( {ω}_{4} t ) \\ = {P}_{2} ( t ) * cos ( {ω}_{2} t ) + {P}_{3} ( t ) * cos ( {ω}_{3} t ) + {P}_{4} ( t ) * cos ( {ω}_{4} t ) .\end{matrix}$$

Without interference from the first signal which may have relatively high power, a second signal may be acquired and tracked in the second channel 52b. The second signal is separated in that second channel 52b, and the initial signal of the third channel 52c is free of interference from the first or the second incoming signals. Similarly, other incoming signals can be separated in other channels.

This discussion has assumed that there are multiple spread-spectrum signals which are modulated respectively by different pseudo-random noise code digital signals, which are known or ascertainable by the receiver. Acquisition and tracking of the individual signals is accomplished more easily if there is a priori knowledge of the local environment in which to search for and lock onto each of the signals. With less knowledge about the local environment of each signal, other techniques are used to match incoming spread-spectrum signals with known or ascertainable pseudo-random noise codes. For example, one technique involves sampling from a set of known codes. Another example involves a system in which a short code is used with a transmitted signal to indicate which pseudo-random noise code is modulating that signal.

Generally, it is desirable to separate the incoming spread-spectrum signals in order of decreasing signal power. There are various ways to determine the order in which the signals are separated. One approach is to use massively parallel correlators to assist in rapid nominal acquisitions on each of the known or ascertainable pseudo-random noise codes. Minimum pre-detection integration and dwell times may be used in a strong signal environment, in which some signals have much greater power than other signals. The largest statistics will correspond with the strongest signals. Another approach is to determine ordering based on a priori information predictive of received signal power. Examples of such a priori information can include ranging data, transmitted signal power, antenna orientation patterns, and irregularities or obstructions in the local geography. Another straight forward approach is for incoming signals to be assigned to channels in the order in which the signals are acquired.

Of course, the best order for separating the signals may vary over time. One way to maintain the best order is to apply the received signal to at least one auxilliary channel which tracks the strong incoming spread-spectrum signals. The respective signal to noise ratios are monitored, and appropriate adjustments in the order for separating the signals can be made over time.

FIG. 5 shows an example in which the initial signal of each channel (i.e., the remainder signal of the previous channel) is applied to the code and carrier loop in that channel. The loop in each channel synchronizes a locally generated pseudo-random noise code with the identical code modulating the incoming signal being separated in that channel. With some incoming signals being much stronger than others, a loop to which a weaker signal is assigned might not be able to lock onto the weaker signal unless the stronger signals are separated before application to that loop. Therefore, it can be desirable to apply the initial signal of that channel to the loop in that channel, as in the example of FIG. 5.

However, this may not be necessary for separation of signals of comparable power. It is possible to apply the initial signal of a prior channel to the loop of a particular channel (instead of applying the initial signal of the particular channel). The loop of the particular channel might be able to perform successfully, because the relative power of incoming signal separated in that prior channel is not so strong that it prevents acquisition and tracking of the signal being separated in the particular channel. In systems flexible enough to perform in this way, the system will respond faster during initial operation and whenever the assignment of incoming signals to channels is reordered.

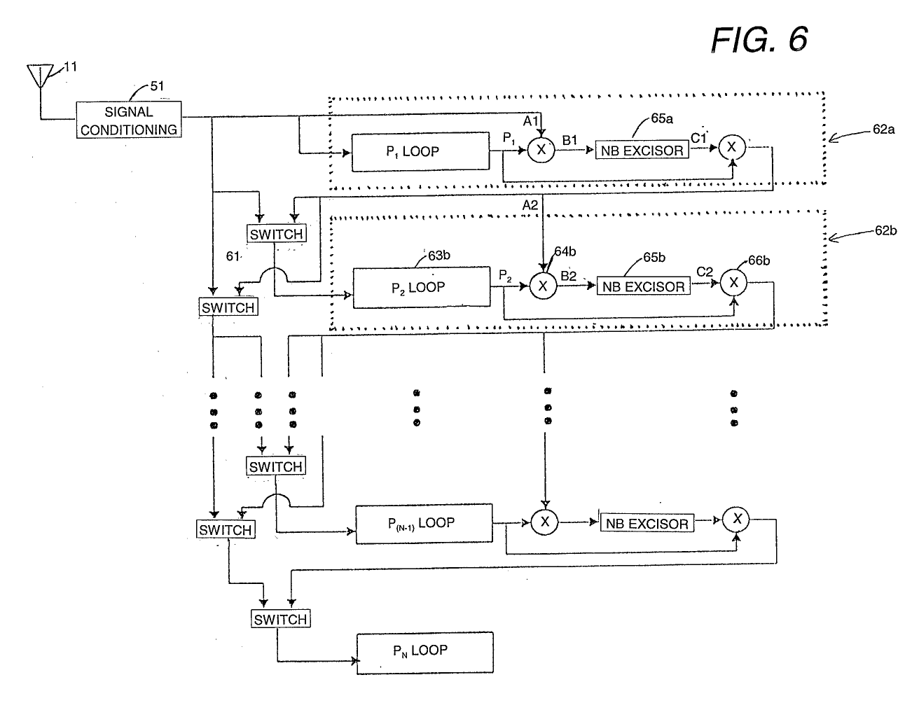

FIG. 6 is an example with “IN” channels in which a switching network has been added. In the example circuit of FIG. 6, the switches connect the channels, and enable application of the same initial signal to more than one channel. The optimal configuration in an example of FIG. 6 is to apply the initial signal of a channel to the loop of that channel, if there is a large variation in power between the signal being separated in that channel and the signals being separated in prior channels. If signal power levels of two or more particular incoming signals are comparable, then the same signal may be applied to the loops of the channels respectively separating those particular incoming signals.

As an example, assume there is a single strongest incoming signal, two other incoming signals each with strength comparable to the other but less than that of the strongest signal, and additional weaker incoming signals. The strongest signal could be separated in the first channel. The same remainder signal from the first channel could be applied to the loops in the second and third channels, for respective synchronization of the second and third pseudo-random noise codes. The second and third signals with comparable strength would be separated in the second and third channels, respectively. Separation of the remaining incoming signals could be performed in other channels, free from interference by the three strongest incoming signals.

Returning to FIG. 6 for another example, switch 61 could direct the received signal at point A1 (rather than the remainder signal of the first channel 62a at point A2) to the P₂ code and carrier loop 63b of the second channel 62b. This is feasible if the power of the second incoming signal is comparable to the power of the first incoming signal, because interence from the first signal would not prevent synchronization of the locally generated P₂(t) with the identical pseudo-random noise code digital signal modulating the second incoming signal.

The locally generated P₂(t) still would be mixed with the remainder signal of the first channel 62a at point A2 (i.e., the initial signal of the second channel 62b). The despread first incoming signal is separated in the narrow-band excisor 65a of the first channel 62a, and is not present in the remainder signal at point A2. That remainder signal is mixed with P₂(t) in mixer 64b to despread the second incoming signal, which is separated by the narrow-band excisor 65b in the second channel 62b. Therefore, neither the first or second incoming signals is present in the residual signal at point C2. Mixing that residual signal with P₂(t) in mixer 66b eliminates the spreading effect of P₂(t) on the remainder signal of the second channel 62b, which is available to be applied in other channels.

Strategies for controlling the switching in an embodiment of FIG. 6 would depend on the application. Signal power information would be necessary to control switching if signal power is used as a discriminator, as assumed in the examples above.

An example of another receiver structure, not shown in FIGS. 5 or 6, would use locally generated composite codes as discussed above in connection with FIGS. 3 and 4. A composite code is formed from more than one pseudo-random noise code. For example, considering FIG. 5, the mixer 56a in the first channel 52a is unnecessary if the initial signal at point A2 of the second channel 52b is mixed with a composite code formed from P₁(t) and P₂(t) (instead of being mixed with just P₂(t)) at mixer 54b.

In examples of other receiver structures not shown in FIGS. 5 or 6, the signal to be applied to the narrow-band excisor (i.e., the signal which includes a despread incoming signal) can obtained from the code and carrier loop. For example, in the second channel 52b in FIG. 5, the signal at point B2 would be obtained from loop 53b rather than from a mixer 54b.

The embodiments discussed and/or shown in the figures are are examples of circuits and methods, for recovering desired signals in the presence of broad-band interfering signals which are modulated by known pseudo-random noise codes. Each example lends itself to different types of desired signals and receiver structures. The best system structure and arrangement will depend on the particular application. The examples discussed and/or shown in the figures are not exclusive ways to practice the present invention, and it should be understood that there is no intent to limit the invention by such disclosure. Rather, it is intended to cover all modifications and alternative constructions and embodiments that fall within the spirit and the scope of the invention as defined in the following claims.

What is claimed is:

1. A spread-spectrum demodulation system for separating a first incoming broad-band signal from an initial signal, the system comprising:
a despreader which despreads the first signal by mixing the initial signal with an initial code, the initial code formed from at least a first code, the first code corresponding with a first incoming code which modulates the first signal;
a narrow-band excisor which separates the despread first signal, yielding a residual signal comprising a remainder signal mixed with the first code; and
a third circuit element which eliminates an effect of the first code on the remainder signal by mixing the residual signal with a composite code, the composite code formed from at least the first code.

2. A spread-spectrum demodulation system as set forth in claim 1, the despreader further comprising a loop circuit which effects synchronization between the initial code and the first incoming code.

3. A spread-spectrum demodulation system as set forth in claim 2, wherein information may be extracted from the first signal in the loop circuit.

4. A spread-spectrum demodulation system as set forth in claim 1, further comprising circuitry for extracting information intrinsic to the first signal.

5. A spread-spectrum demodulation system as set forth in claim 1, further comprising circuitry for extracting information by tracking the first signal.

6. A spread-spectrum demodulation system as set forth in claim 1, wherein the first signal interferes with the remainder signal and has high power relative to power of the remainder signal, the system further comprising circuitry for processing the remainder signal after separation of the first signal.

7. A spread-spectrum demodulation system as set forth in claim 1, wherein the remainder signal comprises a second incoming broad-band signal; and wherein the composite code is formed further from a second code, the second code corresponding with a second incoming code which modulates the second signal.

8. A spread-spectrum demodulation system as set forth in claim 7, wherein software controls composition and phasing of the composite code.

9. A spread-spectrum demodulation system as set forth in claim 1, the system further comprising a signal conditioner for processing an unconditioned received signal into the initial signal, by amplifying and filtering the unconditioned received signal, and by converting a carrier frequency of the unconditioned received signal to an intermediate frequency.

10. A spread-spectrum demodulation system for processing a received signal comprising a plurality of incoming broad-band signals, the system comprising a series of channels, each channel separating one of the incoming signals, respectively, and each channel comprising:
a despreader which despreads the one incoming signal being separated in said channel by mixing an initial signal of said channel with a composite code of said channel, the composite code formed from at least one code, said one code corresponding with an incoming code which modulates the one incoming signal being separated in said channel; and
a narrow-band excisor which separates the despread one incoming signal, yielding a residual signal of said channel comprising a remainder signal of said channel mixed with said one code of said channel.

11. A spread-spectrum demodulation system as set forth in claim 10, each channel further comprising a mixer which eliminates an effect of said one code of said channel on the remainder signal of said channel by mixing the residual signal of said channel with said one code of said channel.

12. A spread-spectrum demodulation system as set forth in claim 10, wherein
the composite code of one channel is formed further from a different code, the different code corresponding with an incoming code which modulates the incoming signal being separated in a different channel; and
the mixing of the initial signal of said one channel with the composite code of said one channel eliminates an effect of the different code on the initial signal of said one channel.

13. A spread-spectrum demodulation system as set forth in claim 10, further comprising parallel correlators which nominally acquire, and monitor signal power of, each of the plurality of incoming signals, respectively.

14. A spread-spectrum demodulation system as set forth in claim 10, where in an order, in which each of the plurality of incoming signals is assigned to a next channel in the series of channels, is one of: an order based on monitored signal power, an order based a priori information predictive of signal power, and an order in which each of the incoming signals is acquired.

15. A spread-spectrum demodulation system as set forth in claim 10, further comprising at least one auxiliary channel to which the received signal is applied; the at least one auxiliary channel tracking, and monitoring respective signal to noise ratios of, at least two of the plurality of incoming signals; wherein an order of assigning each of the incoming signals to a next channel in the series of channels is adjusted over time based on changes of the respective signal to noise ratios.

16. A spread-spectrum demodulation system as set forth in claim 10, the despreader of each channel further comprising a loop circuit which effects synchronization between the composite code of said channel and the incoming code which modulates the one incoming signal being separated in said channel.

17. A spread-spectrum demodulation system as set forth in claim 16, wherein the initial signal of each channel is applied to the loop circuit of the despreader of said channel.

18. A spread-spectrum demodulation system as set forth in claim 16, further comprising a switching network connecting the channels, and enabling application of the initial signal of at least one channel to the loop circuit of the despreader of at least one different channel in the series of channels.

19. A spread-spectrum demodulation system for separating a first incoming broad-band signal from an initial signal, the system comprising:
means for despreading the first signal by mixing the initial signal with an initial code, the initial code formed from at least a first code, the first code corresponding with a first incoming code which modulates the first signal;
means for separating the despread first signal, yielding a residual signal comprising a remainder signal mixed with the first code; and
means for eliminating an effect of the first code on the remainder signal by mixing the residual signal with a composite code, the composite code formed from at least the first code.

20. A spread-spectrum demodulation system as set forth in claim 19, the system further comprising means for effecting synchronization between the initial code and the first incoming code.

21. A spread-spectrum demodulation system as set forth in claim 19, the system further comprising means for extracting information from the first signal.

22. A spread-spectrum demodulation system as set forth in claim 19, wherein the first signal interferes with the remainder signal and has high power relative to power of the remainder signal, the system further comprising means for processing the remainder signal after separation of the first signal.

23. A spread-spectrum demodulation system for processing a received signal comprising a plurality of incoming broad-band signals, the system comprising a series of channels, each channel separating one of the incoming signals, respectively, and each channel comprising:
means for despreading the one incoming signal being separated in said channel by mixing an initial signal of said channel with a locally generated composite code of said channel, the composite code formed from at least one code, the one code corresponding with an incoming code which modulates the one incoming signal being separated in said channel; and
means for separating the despread one incoming signal, yielding a residual signal of said channel comprising a remainder signal of said channel mixed with said one code of said channel.

24. A spread-spectrum demodulation system as set forth in claim 23, further comprising means for eliminating an effect of said one code of each channel on the remainder signal of said channel by mixing the residual signal of said channel with said one code of said channel.

25. A spread-spectrum demodulation system as set forth in claim 23, wherein
the composite code of one channel is formed further from a different code, the different code corresponding with an incoming code which modulates the incoming signal being separated in a different channel; and
the mixing of the initial signal of said one channel with the composite code of said one channel eliminates an effect of the different code on the initial signal of said one channel.

26. A spread-spectrum demodulation system as set forth in claim 23, further comprising means for assigning each of the plurality of incoming signals to a channel in the series of channels.

27. A method for separating a first incoming broad-band signal from an initial signal, the method comprising the steps of:
despreading the first signal by mixing the initial signal with an initial code, the initial code formed from at least a first code, the first code corresponding with a first incoming code which modulates the first signal;
separating the despread first signal with a narrow-band excisor, yielding a residual signal comprising a remainder signal mixed with the first code; and
eliminating an effect of the first code on the remainder signal by mixing the residual signal with a composite code, the composite code formed from at least the first code.

28. A method for separating a first incoming broad-band signal from an initial signal as set forth in claim 27, the method further comprising the step of effecting synchronization between the initial code and the first incoming code.

29. A method for separating a first incoming broad-band signal from an initial signal as set forth in claim 27, the method further comprising the step of extracting information from the first signal.

30. A method for separating a first incoming broad-band signal from an initial signal as set forth in claim 27, wherein the first signal interferes with the remainder signal and has high power relative to power of the remainder signal, the method further comprising the step of processing the remainder signal after separation of the first signal.

31. A method for separating a first incoming broad-band signal from an initial signal as set forth in claim 27, wherein the remainder signal comprises a second incoming broad-band signal; and wherein the composite code is formed further from a second code, the second code corresponding with a second incoming code which modulates the second signal.

32. A method for separating a first incoming broad-band signal from an initial signal as set forth in claim 31, wherein software controls composition and phasing of the composite code.

33. A method for separating a first incoming broad-band signal from an initial signal as set forth in claim 27, the method further comprising the step of processing an unconditioned received signal into the initial signal, by amplifying and filtering the unconditioned received signal, and by converting a carrier frequency of the unconditioned received signal to an intermediate frequency.

34. A method for processing a received signal comprising a plurality of incoming broad-band signals, the method comprising the steps of separating each of the incoming signals in a separate one of a series of channels; and in each of said separate channels:
despreading the one incoming signal being separated in said channel by mixing an initial signal of said channel with a composite code of said channel, the composite code formed from at least one code, said one code corresponding with an incoming code which modulates the one incoming signal being separated in said channel; and
removing the despread one incoming signal with a narrow-band excisor, yielding a residual signal of said channel comprising a remainder signal of said channel mixed with said one code of said channel.

35. A method for processing a received signal comprising a plurality of incoming broad-band signals as set forth in claim 34, further comprising the step of eliminating an effect of said one code of each channel on the remainder signal of said channel by mixing the residual signal of said channel with said one code of said channel.

36. A method for processing a received signal comprising a plurality of incoming broad-band signals as set forth in claim 34, wherein
the composite code of one channel is formed further from a different code, the different code corresponding with an incoming code which modulates the incoming signal being separated in a different channel; and
the mixing of the initial signal of said one channel with the composite code of said one channel eliminates an effect of the different code on the initial signal of said one channel.

37. A method for processing a received signal comprising a plurality of incoming broad-band signals as set forth in claim 34, further comprising the step of assigning each of the plurality of incoming signals to a channel in the series of channels.

38. A method for processing a received signal comprising a plurality of incoming broad-band signals as set forth in claim 37, wherein an order, in which each of the plurality of incoming signals is assigned to a next channel in the series of channels, is one of: an order based on monitored signal power, an order based a priori information predictive of signal power, and an order in which each of the incoming signals is acquired.

39. A method for processing a received signal comprising a plurality of incoming broad-band signals as set forth in claim 34, further comprising the step of adjusting an order, in which each of the plurality of incoming signals is assigned to a next channel in the series of channels, based on changes of respective signal to noise ratios of the incoming signals.

40. A method for processing a received signal comprising a plurality of incoming broad-band signals as set forth in claim 34, further comprising the step of effecting synchronization between the composite code of each channel and the incoming code which modulates the one incoming signal being separated in said channel.
